(19) United States
(12) Patent Application Publication
(10) Pub. No.: US 2008/0306830 A1
(43) Pub. Date: Dec. 11, 2008

(54) SYSTEM FOR RATING QUALITY OF ONLINE VISITORS

(75) Inventors: Ricardo Lasa, Tampa, FL (US); Donald Berndt, Tampa, FL (US)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Cliquality, LLC, Lutz, FL (US)

(21) Appl. No.: 11/759,889

(22) Filed: Jun. 7, 2007

(51) Int. Cl. G06F 17/00; G06Q 30/00

(52) U.S. Cl. 705/26; 705/400; 707/100

(57) ABSTRACT

A system for determine session, visitor, advertiser and/or website click quality scores includes a data warehouse collected from a plurality of websites, a method of determining whether a goal established for a website is achieved, a data mining system for adjusting the value of certain actions taken by a visitor to a website in accomplishing the websites ultimate goal, and a subsystem for reporting click quality scores to users of the system. For example, the system uses a script included in each page of each website monitored by the system to capture data in the data warehouse. The method for determining whether a goal is achieved may include assigning a website goal associated with access to a category of a page and recording the achievement of the goal or goals, when a visitor in a session accesses a page or pages of the specified category. The subsystem for reporting may assist in analyzing the quality of visitors, the quality of visitors referred by a particular referral source, and the quality of a website, including any effects of changes made to the website or in comparison to other websites monitored by the system.

### FIELD OF THE INVENTION

The field is online advertising, especially online advertising based on the number of visitors driven by advertising to a website.

### BACKGROUND

Online advertising has been credited for driving up to 60% of brick and mortar retail sales. Online advertising and promotions through online search engines is also responsible for driving traffic to websites. However, websites want to know that the traffic that is being driving to their website is not merely fraudulent or merely accidental traffic.

Data mining is a learning system that is capable of being used with large data sets to determine rules or lessons that are not otherwise readily apparent. There are many approaches and mathematical algorithms known in the art that fall under the general rubric of data mining. The most well known and one of the earliest is called the “market basket” approach, which is an associations-mining approach. Contrast set learning is a form of associative learning. Contrast set learners use rules that differ meaningfully in their distribution across subsets within a database. Weighted class learning is another form of associative learning in which weight may be assigned to classes to give focus to a particular issue of concern for the user of the data mining results. K-optimal pattern discovery provides an alternative to the standard approach to association rule learning that requires that each pattern appear frequently in the data.

A famous story about associations-mining is the “beer and diaper” story. According to the story, a survey of supermarket shoppers discovered that customers who buy diapers tend also to buy beer. This anecdote became popular as an example of how association rules are able to find unexpected associations from everyday data using the “market basket” approach to data mining.

The input for typical associations-mining algorithm is a set T of itemsets t, each of which is drawn from a set I of all possible items. Each t is a member of the power set 21, but T is not considered a subset of 21 since it may contain duplicates (i.e. a multiset). The general problem of finding all common subsets in an arbitrary selection of itemsets is considered impractical, because the set I is typically very large, Instead, input sets in T, and any results derived from T is assumed to be small, at least compared to I. Research continues in the ability to find algorithms which relax this assumption and allow processing of larger sets. Associations-finding algorithms attempt to find all sets of elements which occur in at least a fraction C of the data, where C is a selected Confidence Threshold (e.g. 2%). The number of occurrences of a subset is called its support. Sets whose support exceeds C are called frequent itemsets. If a set s is frequent, then any subset of s is frequent. Most association-finding algorithms attempt to exploit this fact. Most association-finding algorithms reduce to a traversal of this subset lattice of I in some order, extending frequent itemsets and pruning out infrequent sets and their supersets. This distinguishes most association-finding algorithms from K-optimal pattern discovery methods.

The fixed confidence threshold (C) is not a statistically valid confidence interval and has little statistical support, because it has been shown that some sets may exceed it simply by random coincidence and meaningful associations may be filtered out without reaching the threshold. Thus, this approach has both false positives and false negatives. With an understanding of this limitation, the method does allow elimination of insignificant sets, allowing significant sets to be identified and further validated. For a given data set, the set of its frequent itemsets can be described by its maximal frequent itemsets, which are frequent itemsets S that are not subsets of any larger frequent itemset T. During mining, finding maximal frequent itemsets first allows their subsets to be skipped, an important improvement if sets are large. As the size of the data set increases, the problems of the associations-mining method grow exponentially, either preventing detection of low frequency patterns or overwhelming meaningful patterns with meaningless noise.

K-optimal pattern discovery avoids these problems. K-optimal pattern discovery is able to data mine attribute-value data. Attribute-value data is a collection of cases, each described by a number of attributes. Each case has a single value for each attribute. Attributes may be categorical or numeric. A typical example is a customer database. In this example the cases are customers. Attributes might include amount spent in each of a store's departments, behavioral information, and socioeconomic descriptor. A name file is defined that lists the attributes of interest and the categories and or numerical ranges to be considered. A cases file is a database file containing a list of attributes for each of the cases. In the simplest form, data is imported into a data mining tool and rules and datasets are output based on user defined criteria, such as leverage, lift, strength, coverage, and support of the rule or itemsets. For example, the output may be ordered according to the user defined criteria and the output may be limited to a certain number of associated itemsets. The choice of defined criteria is within the ordinary skill in the art. An example for one tool, requires input as name file having each attribute listed in the same order as the order of the same attributes in each line of a cases file. Thus, the categories and numerical ranges are identified for the data mining tool for each attribute. Even for this simple structure, is capable of providing sophisticated associations between seemingly unrelated attributes.

Neural networks may be simulated in software. They are often used to train neural net software to identify patterns that may be used in artificial intelligence or expert systems.

### SUMMARY

A system rates the quality of online visitors to a website. In one example, an advertiser score is provided for advertising that refers traffic to other sites. For example, the traffic directed by main search engines, such as Google and Yahoo, may account for a larger percentage of online traffic, with or without additional advertising on pages showing search results. Nevertheless, it is thought that targeted advertising in response to terms entered into such a main search engine should be able to drive traffic that has a substantial interest in the product or service advertised on a search page.

One advantage for a system of rating the quality of online visitors to a website is that a controller of the website may be able to determine not only the amount of traffic driven to the website by a source, such as a main search engine or an advertisement, but also the relative quality of the visitor, based on parameters captured about the visit and the source of the visitor. Another advantage of a system of rating according to the examples presented is that the system is capable of rating the click quality of visitors to many websites monitored by the system (i.e. not just a single website), of advertisers sending visitors to many websites monitored by the system, and of websites monitored by the system. Thus, a comparison may be made between the click quality of visitors to one website and other websites, between one advertiser and other advertisers, and between one website and other websites. For example, websites of one web hosting service, such as Web Piston, may be compared to other web hosting services, and one advertiser, such as the search engine Google, may be compared to another advertiser, such as the search engine AltaVista, for example.

Another advantage of a scoring system, according to one example of the present invention, is that the scoring system is capable of rating, such as by an objective and automatically adjustable criterion, the quality of individual visits to a website or globally to any of the rated websites, as well as aggregate traffic streams from advertisers and other websites that forward visitors to a website, within the framework of a single scoring system. In one application of the system, a website designer may use the information obtained from the scoring system to objectively determine improvements to the website. For example, a change to the website may be implemented, and the scoring system may provide a report showing user quality scores before and after the change to the website. If visitors achieve objectively higher scores for certain desired objectives, such as putting an item in their shopping cart or purchasing an item from the website, after the change, then the change to the website is validated. If the opposite occurs, then the change may have the opposite effect to that intended by the designer, driving customers away from the website.

Also, a comparison of the behavior of visitors, using session quality scores of visitors in other websites and an evaluated website may be used to compare how well an evaluated website is doing in meeting its objectives compared to other websites. In one example, a one-to-one comparison may be provided by comparing aggregate visitor quality scores of an evaluated website to aggregate visitor quality scores of a specified website. Alternatively, visitor quality scores may be compared based on actual specific visitors in common with both websites. The former comparison includes the quality of visitors accessing the website and the ability of the website to close a sale, which might include price, reviews, information made available, ease of making a purchase, and other design elements. The latter, which compares the same visitors, removes the difference in visitor quality. In another example, a one-to-many comparison may be provided that gives a website a score based on an aggregate of all websites or a subset of websites relevant to the website being evaluated. Again, this may compare an aggregate over all visitors and/or sessions or may be limited to certain visitors that were common to one or more of the websites used for comparison. Thus, the effect of visitor quality score may be separated, at least to some extent, from the elements of design, price, shipping, good will, ease of purchase, guarantees, and other elements differentiating one website from another. Other factors may be similarly evaluated, if a website is willing to adjust individual elements, such as price, shipping services used, promotional discounts, and the like. In another example, factors are differentiated by adjusting multiple elements known to affect session quality scores in a design of experiments approach, to provide a correlation coefficient for the relationship between specific elements and a desired outcome, such as putting an item in a shopping cart, adding additional items to a shopping cart, and making a purchase. A system may also be correlated with driving sales to “brick and mortar” stores, if adjustments are made for seasonal variations and statistical methods are used for accounting for randomness and other factors. For example, a website may be edited to drive sales to one local store rather than others within the same geographical area for a significant period, in order to determine the effect of online advertising in getting online visitors to make purchases in local, “brick and mortar” stores. Adjustments to the website may be made in an iterative process to improve the quality of the website design, which may be objectively measured using the scoring system. In one example, the effect of online visitors on sales and/or visits in all local stores may be determined by a statistically adjusted changes upon launching or substantially changing website parameters. One website parameter that may be changed is the location of the website in search results returned by a search engine query, for example.

Online magazines and newspapers, such as CNN, the Drudge Report, and Fox News, social networks, such as My Space, online content providers, such as YouTube, and other types of online sites of interest to those surfing the web are being used to refer traffic to other websites that can benefit from the traffic generated by visitors being redirected to their site. For example, in exchange for driving visitors to commercial websites, these referral sites are being paid. In some cases, the payment may be substantial if a large number of referred visitors buy from the website. Retail websites, such as Amazon, may pay a small finder's fee for traffic driven to the Amazon website, but click fraud and web surfing visits do not necessarily guarantee sales. A system for rating the quality of visitors provides retail or other commercial websites with a basis for making marketing decisions about who to pay, what type of visits to pay for and how much should be paid. The system allows a website to report fraudulent purchases or other fraudulent or ineffectual obtaining of the ultimate goal, which may be factored into a quality score system, such as fraudulent use of a credit card or completing contact information field with a non-functional or spoofed email address. The system may be automatically self-correcting, if the session score is changed from a best to a worst score, based on confirmation and validation steps.

A session may exist without a referring site, if the visitor enters the site by typing the site address in a browser or choosing from a favorites list. This may be included in the system.

### BRIEF DESCRIPTION OF THE FIGURES

The drawings and examples provided in the detailed description are merely examples, which should not be used to limit the scope of the claims in any claim construction or interpretation.

FIG. 1 illustrates an example of using data mining of a data warehouse capable of storing data relevant to certain website goals to make scores relative to a comparison of scores rather than absolute.

FIG. 2 shows fields in an example of a first level of a database.

FIG. 3 shows fields in an example of a database structure for recording raw database sessions.

FIG. 4 shows fields in an example of a database structure for capturing information about a session profile.

FIGS. 5A-5C show fields in an example of a database structure used in determining a Cliquality™ quality score, based (B) on a visitor profile or (C) an advertiser profile, using data from a plurality of session in (A) session profiles.

FIG. 6 illustrates layering of a neural network in an example of a system for determining relative quality scores predictive of achieving an ultimate goal set for a website.

### DETAILED DESCRIPTION

Herein, “brick and mortar” is used as a term of art, to include a retail store where a customer is able to physically go and buy a product or service. However, the definition includes services that come to the consumer, such as repairman, installers and the like, who have a physical presence in the geographic location of the consumer, whether or not they have an office or other location that a consumer could physically visit. For example, this more expansive definition would include a heating and air conditioning installation service that services a local geographic area. The difference between a “brick and mortar” physical presence and an online retailer that contracts out delivery or installation services that are arranged entirely online is much more than semantics. A website driving business to “brick and mortar” services, such as repair, installation, legal, but does not complete purchases online has different goals than a website that has a checkout and payment service for concluding a purchase of goods or services. The ultimate goal of the website is distinguishable between the website of on online retailer and a website for referring a potential customer to a “brick and mortar” store or a local referral of a client to a professional/consultant/sales agent, such as a realtor, attorney, electrician, physician, dentist, plumber, car dealer, and the like. Entering an email address and contact information or selecting a local store from a list of stores is different than paying for something with a credit card, third party payment system, debit card, cash or a cash alternative. Nevertheless, this may be the ultimate goal of a website, and it may receive the same quality score as completion of payment for a good or service. In this example, if a statistically significant comparison is to be made between website having different types of goals, then some factor may be needed to adjust the scores to compensate for the effect of a difference in ultimate goals or type of website.

Alternatively, the quality score for a website with an ultimate goal that is not the actual ultimate goal (i.e. a referral instead of a sale in a “brick and mortar” store) may have a maximum score of less than ten on a scale of one to ten. This type of website may have a scale from one to a value less than ten. The difference may be statistically determined, such as by a study to determine the effectiveness of a referral in driving actual business to a “brick and mortar” store. In a simple example, if it is known that 50% of referrals from a website actually purchase a good or service, then the website scale may be limited to a maximum of five on a scale of one to ten for achieving its objective of referring a visitor to a local retailer or service. In this example, a statistically significant comparison may be made between websites have quite different ultimate goals. Adjusting the maximum value of the scale, according to this example, may be used as a weighting algorithm for comparing websites of different type or having different actual ultimate goals than the ultimate goal measurable online. Other alternatives are also available for weighting of different factors, including making everything relative based on data mining algorithms.

In one example on a scoring system, any visitor referred by an online property at a first website, by clicking on the paid advertisements of a search result, a banner ad, a hyperlink or otherwise, to a second website is recorded and data for that source is gathered by the system. Over time, a score for the quality of visitors referred by the first website is determined. As additional data is collected the score may be modified, either from time to time or continuously. This score allows the first website owner and the second website owner to determine whether the first website is referring the right kind of visitors to the website. The owner of the second website may determine, for example, which of several main search engine sites are delivering the best visitor traffic to its website. Thus, a click quality score may be determined for each identified visitor to one or more websites, each session, each advertiser or aggregates thereof.

The system is capable of monitoring many websites for visitor traffic and is capable of identifying the unique signature of each visitor, through a unique identifier. In addition, each website monitored may receive a score for the click quality of visitors to the website compared to other websites, which may be categorized, such as retail, non-profit charitable institution, informational, referral and the like. The level of categorization may be finely detailed. Websites may be categorized for sale of autos or pre-owned autos, for subscriptions to magazines or on-line journals, and for legal services or patent attorneys, for example.

Each advertiser driving traffic to a website may be scored for the click quality of visitors to monitored websites by parsing the information received from the advertiser, which may be stored in a data warehouse, for example, and relating the advertiser to the click quality of visitors driven by the advertiser to one or more websites monitored by the system. For example, a visitor from one advertiser, such as a search engine, may have a higher click quality, because the visitor has a higher click quality than comparable visitors from other advertisers. This would improve the advertiser's score only if the advertiser had a proportionately greater number of users with high click quality scores. In another example, while the visitor's click quality scores are no better than its competitors, nevertheless, the advertiser does a better job of targeting advertisements to drive visitors to websites that truly interest the visitors. In this case, the score for the advertiser may be better than its competitors scores even though the visitors of the advertiser have the same or even lower click quality scores than the users of competing advertisers.

For example, one system scores each visitor, each session, each website, and each advertiser, by identifying each visitor, each session, each website and each advertiser in the data warehouse, collecting information in the data warehouse, and providing scores by determining the quality of a session that then is roled into a user, site, and advertiser score. None of the other statistical systems known to the applicant are capable of providing this information. Systems fail to detect the quality of traffic if they are limited solely to monitoring a single website.

In one example, the system may provide a type of rating that influences the amount that website owners value online advertising opportunities. Online advertising opportunities that drive both a high volume and high quality of traffic to a website may be valued greater than opportunities that fail in either of these categories.

For example, each online property referring traffic may have its own quality score (QS). A QS may be used to determine if there is substantial fraudulent traffic generated by an online property (i.e. click fraud), which is a significant concern. Click fraud can generate revenue for websites paying individuals or implementing “bots” to drive fraudulent traffic to a website, causing an online retailer to pay for fraudulent traffic and using server resources to handle the fraudulent traffic. Based on a QS of the system, if click fraud is suspected, an investigation may be initiated or the system may generate blocking filters to prevent continued click fraud. For example, a source may be black listed.

In one example, a black list is the compilation of sites that are known to be parked pages used for paid per reading click fraud. As sites get black listed, any click coming from that site into any site running the system may be immediately marked as fraudulent.

However, a QS may provide much more information than merely whether or not an online property is generating click fraud. The system uses online behavior analysis spanning multiple visits to multiple sites to identify the quality of a source, providing a QS. In one extreme, such as source may be black listed, with or without notice to the source. In another extreme, a source that drives traffic having a beneficial QS may be provided a premium advertising rate or a bonus.

A QS may relate to each individual site visitor that is uniquely identified by an identifier or code that follows the visitor during multiples sessions and across a plurality of sites. A QS may flag such as visitor as high or low quality and may be adjusted over time. For example, a QS may be an aggregate, either weighted or unweighted, score of individual scores that each user profile is made from.

In one example, each site has a site score that allows each site to see the quality of the traffic they are receiving. The site score is computed by aggregating, either weighted or unweighted, the scores for each of the site visits. A site score may be used to benchmark a site's performance compared to similar sites. For example, a system may be based on a “session” which includes all of the activity within a site during a single visit by a visitor. A database may maintain information about each session, such as a session score, or such sessions may be combined into a cumulative score, with or without access to the data generating the cumulative score. In one example, a premium subscription provides access to additional information not found in a cumulative score, for example.

In one example, the QS is determined by comparing visitor behavior to “good” and “bad” site behaviors. For example, in order to know what a “good” behavior versus a “bad” behavior is, the system considers the purpose of the website and evaluates its structure.

### SPECIFIC EXAMPLES

In one example, a “good” behavioral pattern is determined according to the following process. A site owner registers with the system and enters a site profile assistant. The site profile assistant gathers information from the site owner, such as the site name, URL, purpose, and platform to populate a first level of a database. Some of the information entered in the site profile assistant is used to determine the goals of the site owner, including an ultimate goal, such as an online sale for a website that is geared to driving internet-based sales, which is given the best quality score. For example, the best quality score may be a score of ten on a scale from one to ten. Alternatively, the best quality score may be a one on a scale from one to five. Regardless, some numeric value, or equivalent thereof, is assigned to the ultimate goal of the website. Some ultimate goals may be on online sale, a referral, selection of directions to a local “brick and mortar” store, an online donation, an online obligation to make a donation, completing a contact form, a subscription to an information service (even if free), and the like.

For example, the site purpose may be classified according to the following purposes: E-Commerce, Informational, Social Networking, Custom, or combinations of these. The site platform may be classified according to the following platform types. For an E-Commerce purpose the platform type may be a Web Piston Store, a Miva Merchant, a Storefront.net, a retail site and combinations of these. An Information Site purpose may include platform types such as a Website Builder, a Homestead, a Web.com, an Ibuilt.net, a CityMax, a content site, or combinations of these. A Social Networking purpose may include platform types such as a Website Community, a One Site, a social networking platform, or combinations of these.

Additionally, an industry code, such as a SIC code or NAICS code, and contact information may be requested and stored by the system. Preferably, an industry code defines a relevant category of online activity, and this may include codes defined to fit customized peer groups.

The system may establish, automatically or manually, an adjustment to the way that the system compares good and bad visitor behavior based on the input site type/platform pair. For example, many websites are built using standard platforms, menuing and paging. The system may determine the page map for most site type/platforms pairs, automatically, based on an understanding of these standards and any variations discovered during system setup. Ordinary visitors to one of the type/platform pairs tend to have certain recognizable patterns in their evaluation of the website and levels of the website searched. Thus, there are recognizable behavior patterns that are expected for real visitors. For example, for a Website Store, which is an e-commerce platform, with the purpose of selling online merchandise, “good” online behavior would represent a user that goes through the site, finds a product or service (an item) and purchases the item. Even better would be a visitor that returns to the Website Store and purchases additional items. For example, the following behaviors might be considered “good” behaviors for an online visitor: putting an item in the shopping cart, proceeding to checkout, and purchasing an item.

Each of these “good” behaviors may be traced by the system, such as using a cookie or single pixel tracking system. In one example, putting an item in a shopping cart is associated with a ShowShoppingCart.asp, going into checkout is associated with Checkout1.asp, and purchasing an item is associated with Checkout4.asp.

Each time a goal is achieved, the QS for the session may be increased. Other tracked behaviors may include browsing a category, looking at a product, spending at least 30 seconds on a page, putting an item into the shopping cart, and checking out. The QS for a session may improve from 0 to 1 to 2.5 to 4.5 to 7 and to 10 from the start of such a visit to the purchase of an item, with 0 being clearly a “bad” visit and 10 being clearly a “good” visit.

Likewise, certain “bad” behaviors may be used to reduce the QS. Click fraud detection algorithms may be used to determine both fraudulent human and clickbot behavior. A score of zero or negative in this context would be considered fraudulent, for example. Spending less than a threshold time period, such as less than one second, on any web page might be an indication of click fraud, for example. Repeatedly clicking on the same sequence of pages might warrant a negative rating, for example.

An initial behavioral map may be established automatically for users of the system, which may be tailored automatically or manually to the platform and type of the website. Initiating the behavioral map automatically and updating the behavioral map automatically provides a substantial advantage over any manual system, because the automatic system may be applied by the system to a large number of websites, which has the capability of identifying click fraud sources more readily, which may be added to a black list, for example. Also, changes to the automatic system to adapt to changing methods by click fraud sites is immediate. Also, an automatic process makes setup for an owner or operator of a website very easy and short.

In another example, custom behavior mapping is provided for non-standard website platforms/types. For example, a system may be able to map “good” behaviors by allowing the site owner to teach it what represents a “good” behavior by example. For example, the system lets a website owner or operator to have someone browse through the site to determine what good behaviors are. As one example, a custom website for a non-profit organization, which generates leads through a contact form, may record “good” behavior using following this process:
The site user starts recording the good behavior.
The user clicks on menus or tabs to read about the non-profit.
The user is directed to a contact form.
The user completes the contact form.
The user submits the contact form.
The user stops recording the “good” behavior
The system records each of the steps in the path and time spent viewing a page and categorizes these behaviors as a “good” path pattern.
The user may repeat this process many times to capture all of the typical good behaviors that the user wants to identify to the system.

Then, the system uses the “good” paths to assign each visitor session a QS or session score.

Alternatively, the system may be self learning (or self teaching). The system may use data mining technology to define the default and custom “good” and “bad” behavior patterns to determine the real “best” behavior patterns. For example, the self learning engine assigns and modifies the predetermined scores for behavior after gathering and analyzing data for the site. It therefore learns as time progresses. For example, it might learn that most people that reach the ultimate site goal, such as buying an item, first search for at least 3 items, or put an item in the shopping cart and search again, or browse at least 2 products or return to the website within twenty-four hours. Therefore, the “best” site behavior pattern for a user would be to mimic one of the examples above. This learning of “best” behaviors then is used to determine the assignment of the session score and may be the most accurate way to assess the quality of visitor behavior.

When a visitor accesses a site that uses the system, the session tracking starts aggregating the visitor behavior into a session score. The session score is a score for that specific visit to that site. For example, a site selling high end dog products called poochigans.com receives a visit. The session score is computed by comparing the visitors' actions to the “best” behavior patterns and increasing/decreasing the user score based on actions taken. For example, the following scenario might occur:
Session starts. The user gets to the website. The Session Score=0
User clicks on the gourmet treats category. The system has a +1 session score when a user clicks to see a category. Therefore the Session Score=0+1=1
User clicks on a product displayed for that category to see more details. The system score for viewing a product detail AND staying on the page more than 30 seconds is +1.5. The user reads the whole product description staying on the page for 45 seconds. The Session Score=1-+1.5=2.5
The user goes back to the home page. The Session Score is untouched.
The user clicks on the back button to see the product again.
The user adds the product to the shopping cart. The system adds +2 for adding an item to the shopping cart; therefore, the Session Score=2.5+2=4.5
The user proceeds to check out. The system adds +2.5. The Session Score=4.5+2.5=7
The user completes the purchase. The system adds +3. Therefore, the Session Score=7+3=10, which may be the maximum available session score, for example.
The session ends and the system records the Session Score.

The value assigned by the system to the different steps and actions taken on a website may be self adjusting, automatically. The weights of each step may be determined by the “best” patterns of behavior and the final goal of the website owner or operator, as defined in initial setup, for example. For example, if the hypothetical user would have left the site after adding the product to the shopping cart, the score for that session would have been a 4.5, which might be considered a low score. If this pattern occurred repeatedly without any purchase of an item, then a score of 4.5 could be assigned as a “bad” score or even a fraudulent score. Alternatively, the value assigned to the steps might be reduced by adjusting the weighting in order to decrease a cumulative QS to less than the threshold for a “bad” score. In the extreme, if a visitor came to the site and immediately left, the score would be 0. In one example, a score might even be negative if indicators of click fraud are detected.

In one example, when a visitor starts a session as described above, the first thing that happens is the assignment or retrieval of the user's unique identifier. For example, the first time the user visits the site, a unique identifier is assigned to the user. If the user has been to any site administered by the system before, the visitor's unique identifier is returned by the system, such that the session score is associated with that visitor. A QS may be assigned to the visitor and/or the source generating the visitor.

As a visitor finishes a particular session, the session score is tied to the profile and modifies the visitor score of the visitor's profile. Following the prior example, once the user purchased the product and exited the site, his User E-Commerce Score is modified. A visitor purchasing items tends to have an increased QS over time.

For example, a new visitor upon finishing the first visit gets assigned the Session Score. As the user initiates other sessions by visiting the site again or any other site running the system, then each session score is used to modify the visitor's QS. This may be an average of all Session Scores, for example. The more the user visits sites and purchases, the higher the score. Alternatively, if a user never purchases an item ever again and continues to visit sites monitored by the system, then the QS of the user may be reduced over time.

In one example, the system uses a subset of scores for visitors, which may be referred to as a user category score, and weighting to assign a QS from 1 to 10 by averaging category scores over a number of visitor sessions. For example, the system may keep a running average based on the number of sessions. User Category Scores may include one or more of the following categories: E-Commerce, Informational, Social Networking, and Click Fraud, for example.

For example, a process for computing the visitor's E-Commerce Score may include the following. A visitor purchased on this first session, resulting in an E-Commerce score of 10. The same visitor then went to another E-Commerce site monitored by the system and purchased again, resulting in an average score calculated as ((10+10)/2), which equals 10. The same visitor then went to yet another site and exited immediately, resulting in an average score calculated as ((0+10+10)/3), which equals 6.7. The 0 in the last session being caused by bad behavior is averaged in with the other session scores to determine a new QS for the visitor. is the Session Score returned by this last visit since he just left as soon as he got to the home page.

As a visitor continues to visit site monitored by the system, the visitor QS may be constantly updated. In one example, the same process applies to all platforms/types. However, in alternative examples, the weighting provided to sessions on different platforms/types may be weighted differently. For example, a score from an e-commerce category receive a greater weight than a session score of a non-profit category.

The overall QS of a visitor may be determined by adding and weighting accordingly different Category Scores. For example, the E-Commerce Score holds more weight for the QS of a visitor than the weight given to the Social Networking Score of the visitor.

For example, the following example may be used for a user:
The E-Commerce Score is 6.7 (purchases on E-Commerce sites)
The Informational Site Score is 8 (avid user of informational sites)
The Social Networking Score is 2 (does not visit or participate in Social Networks too much)
The Custom Score (for other site types) is a 7

Overall score is determined in this example by applying a weighted average. For example, an overall QS may be 7, as compared to an unweighted mathematical average of 5.92, provided that the Social Networking Score carries much less weight than the Custom, Informational and E-Commerce scores.

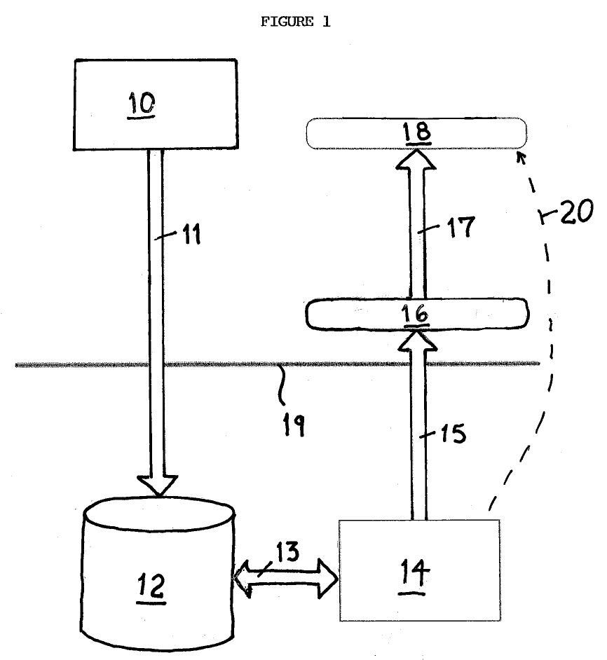

In one example, the system self adjusts weighting applied to each of the category scores based on algorithms adopted from Data Warehouse and the Data Mining, such as the system shown in FIG. 1, for example.

As illustrated by the flow diagram of the system of FIG. 1, a website 10 or webserver may be setup to capture data about sessions and to report 11 the data to be stored in a database 12. Preferably, the website 10 or webserver is a plurality of websites or webservers, each of which is setup to capture data about sessions that may be reported and recorded in a data warehouse 12.

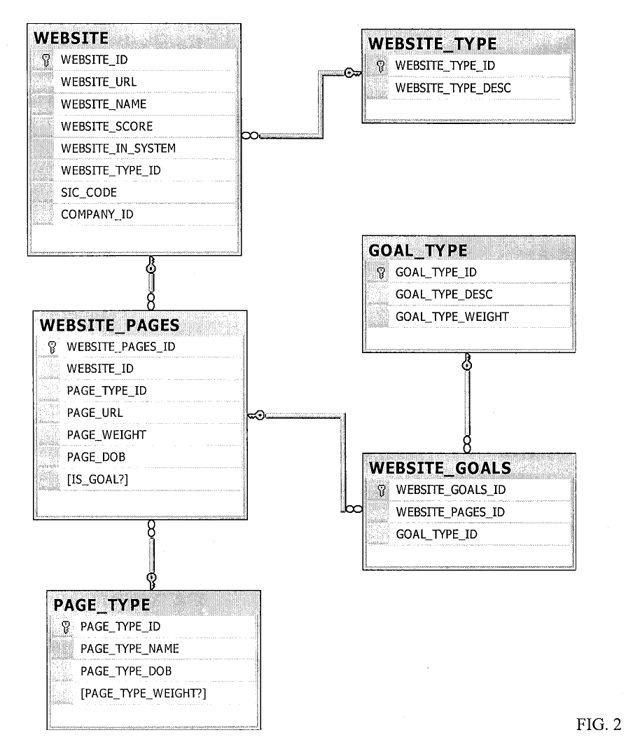

For example, a script may be installed, such that any access to a webpage of a website during on online session by a visitor is reported II to a service and is recorded to a database, such as a data warehouse 12, as shown in FIG. 1. In one example, each web page is assigned a page categorization PAGE TYPE ID, such as shown in the fields of FIG. 2, during a setup process, which may be a manual setup process or may be automated for website formats recognized by the system. An automated system is preferable, because manual setup may be time consuming and may be more prone to random errors, if a natural person is required to set up a complicated website like an on online retail website, for example.

In one example, a website development tool, such as Web Piston™, automatically sets up a website for reporting to the system by categorizing pages and inserting a script and/or single pixel gifs and/or routines for cookie handling, within a website developed using the system. Alternatively, the system may analyze a website to determine if the website was developed using one of the known website development tools. If a known website format is identified, then the system automatically modifies the website to add features, such as scripts and cookies, for tracking sessions and reporting to the system.

No other example is known of a system that tracks access to every webpage of a website by each visitor to the website across a plurality of websites on the internet. This offers a substantial advantage in data mining and determining quality scores, such as those for sessions, visitors and advertisers. By making every webpage monitored, it is much more difficult to make a “bot,” which is a fraudulent or inadvertent cause of low quality sessions, to have a pattern appearing similar to a natural person, if a system globally tracks access to all webpages. Some of the webpages are associated with intermediate goals and/or an ultimate goal, such as a purchase. The amount of data and ability to mine the data using data mining tools and/or neural networks makes identifying patterns that lead to the ultimate goal distinguishable from patterns that fail to lead to the ultimate goal. Furthermore, the system may capture data in a data warehouse 12, which may be updated to avoid the use of fraudulent credit cards, email addresses or the like in reaching the ultimate goal of the website. The system is capable of closing the loop by having the website report a session ID related to a fraudulent (or inadvertent error) use of a credit card, email address or the like. Thus, even if a page associated with the ultimate goal is accessed, the session score for a fraudulent session may be assigned the worst score possible in the scoring system, for example. Systematic fraud may be distinguished from inadvertent errors and high quality sessions that lead to successful outcomes. If systematic fraud occurs, then the patterns associated with access to webpages assigned to categories may be associated by the system with the fraudulent access, and the system may distinguish the patterns associated with fraudulent access from patterns associated with high quality sessions that ultimately lead to a successful outcome, such as a purchase on a retail website, a delivery of a newsletter to a new email address of a subscriber who does not block or request immediate removal from distribution of the newsletter, a fulfilled pledge by a new donor to a charity, or the like. The depth of data in the data warehouse assists the data mining and/or neural network analytics to distinguish patterns of low quality sessions from patterns associated with high quality sessions. The same is true for distinguishing patterns associated with low quality visitors, who lurk but fail to ever reach successful outcomes, from the patterns associated with fraudulent visitors, who attempt to fake high quality patterns, and distinguishing both low quality visitors and fraudulent visitors based on differences (and similarities) between these patterns and the patterns of access to webpage categories associated with high quality visitors. By categorizing webpages to certain webpage categories, the size of the database is much reduced, and the system is capable of running data mining and/or neural net analytics on a much reduced dataset, compared to a system that would store session analytics for each and every page ID.

In one example, the page ID is sent to a processor, which identifies the page ID with a category assigned in the data warehouse for the page ID. In another example, the website sends the webpage category, which is stored on the website side of a security barrier 19. The security barrier 19 may be a firewall. In one example, a security barrier 19 is implemented by having a database, such as a temporary database, store data on a session. Using a temporary or intermediate database as part of the barrier 19 may be capable of reducing erroneous reporting of data from entering the data warehouse 12 that is accessed 13 by data mining and/or neural net analytical and/or query subsystems 14 that are used in analyzing data and determining click quality scores, such as session scores, visitor scores and advertiser scores. By adding one or more barriers 19, the integrity of a data warehouse 12 may be protected. A data warehouse 12 may be distributed and historical backups of the data warehouse 12 may be maintained for restoration of lost or corrupted data, as is well known in the art of data storage and management. If one distributed node in a larger data warehouse becomes corrupted or lost, then the node may be taken offline until it may be restored or replaced.

The subsystem 14 may report 15 data and quality scores in a report 16 to a user of the system. This may be stored in another database or may be used in other ways by the user, such as to identify leads or to provide incentives for a visitor to make a purchase or to add an item to other items in a checkout basket. Aggregations of session scores and data may be used to report 17, 20 a visitor click quality score 18 or an advertiser quality score 18 to a user of scores provided by the system. A visitor click quality score or advertiser quality score may be based on a plurality of sessions to one website or may be based on data in the data warehouse on sessions monitored across a plurality of websites. In one example, two advertiser quality scores are presented. One is based on session quality scores for the advertiser on one particular website. The second is a score based on a plurality of sessions across a plurality of websites. Both scores may be relative comparisons to other advertisers and may have different levels of granularity based on industry type, type of website, and other attributes identified from information stored in the data warehouse. In one example, a report is customized by a user. In another example, a report is customized based on the industry and type of website operated by the user receiving the report.

In FIG. 2, information is input about the website in the data warehouse. In the example shown in FIG. 2, a known software platform is selected, either automatically or by way of prompting. A website ID is assigned, and data is entered into the website fields, including website URL, name, and the other fields shown in the example. The system may determine the information based on information known about certain commonly used website builders, populating the fields automatically for known website designs and/or someone, such as a website designer or owner, may input certain information about the website either in free form or by direction of a step-by-step guide. Thus, fields in FIG. 2 are populated, in this example either automatically, by a knowledgeable user, by a person having no prior knowledge of the system and/or combinations of these.

For example, a system assigns a page type ID according to categories of page types, such as information pages, catalog pages, detailed product pages, shopping cart pages, checkout pages, and purchase pages for an online retail website. Access to certain page categories and time resident at those pages may be stored in a data warehouse, using data fields such as the ones shown in FIG. 2, for example.

In one example, an informational page may be a home page, about us page, contact us page, privacy statement page, terms of use page, copyright policy page, returns policy page and the like. A catalog page may be pages used to see the inventory of the website, display categories and subcategories, lists of products, such as by category, brand, manufacturer, and the like, and pages listing details or descriptions of products, reviews and the like. Shopping cart pages may be pages used to add items to a shopping cart, update shopping cart quantities, or delete items from a shopping cart. Checkout pages may be pages used to checkout prior to purchase including shipping information pages, payment and billing data pages, other processing pages. Purchase pages may include payment processing pages, purchase confirmation pages, receipt pages, and are normally associated, for online retail websites, with the ultimate goal of the online retail websites, a confirmed sale or purchase of an item or service.

Once data is entered for the website, in the website fields, and the website pages and page types fields, then either a person or the system completes the website type, goal type and website goals fields. This completes the first level of data entry for a website data warehouse, as shown in FIG. 2. This is repeated for each website to be analyzed, and the process may be automated to capture as many websites as possible. Thus, a plurality of websites are fully mapped and categorized in the data warehouse, with the websites ultimate goal identified, either automatically according to known website configurations or by a custom setup that allows a person to enter some or all of the information needed to fully map the website to the data warehouse website fields.

A SIC code or NAICS code may be entered for the website, which may be used to compare websites within a specific, common SIC code or NAICS code. This is an optional feature, which may be added later by either the system, identifying common features of websites to identify the appropriate code, by a system specialist, or by someone who is responsible for the website and wants to compare it to other websites within the same code. For example, this may be entered during a query by a website operator asking for a click quality report from the system. This code, or a plurality of SIC and/or NAICS codes, may then be stored in the data warehouse and may be associated with the website ID. Other data fields may be populated similarly, as data is gathered during use of the system.

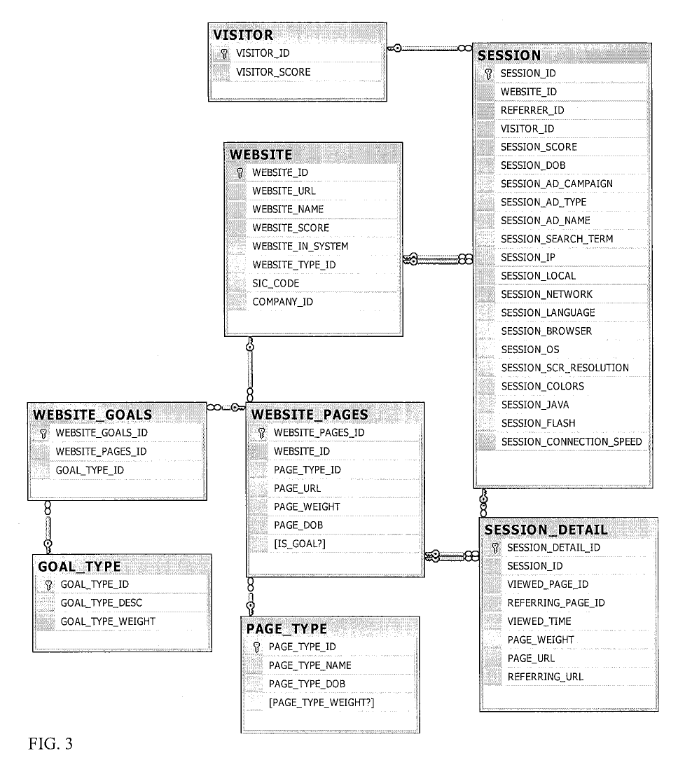

In one example, a script is included in the code for the website. This may be JAVA script or a .NET script. The script may be included in every page of the website, automatically during website development or by installation using an installation program executed by a person responsible for a website, for example. The script acts to populate fields in a data warehouse structure, such as the one shown in FIG. 3, for each session initiated on a website by a visitor. The script associates such data with the correct webpage ID's and may capture information about visitors. Thus, a website mapped and scripted starts referring information to the data warehouse during each session initiated by a new or returning visitor. Returning visitors may be identified by cookies residing on the visitors computer system, for example. Cookies are well known devices for collecting information on visitors and recording the visitors preferences, for example. Almost all visitors to a website accept first party cookies from the website, itself. Many websites will not function unless cookies, at least first party cookies, are accepted by the visitor to the website. The system may be capable of using these first party cookies to identify and collect data on sessions for such visitors. Any deletion of first party cookies may make the system treat the visitor as a first time visitor. Alternatively, information obtained from the website or domain name referring the visitor may be used to identify the user, in addition to any identification determined from cookies.

Once a plurality of websites begin referring session data to the system, a data warehouse populates fields associated with each session, such as the fields shown in FIG. 3, including visitor fields, session fields and session detail fields, for example. These fields are related to the website that refers the session to the system. A session score may be derived from the entry of data into these fields. The website ID identifies the website, the referrer ID identifies the source of a visitor, such as a content site, a social networking site, a search engine site, a weblog site or any of the other types of referral sources. The URL of the referring website may be recorded, as well as information about how the visitor, associated with an assigned visitor ID, entered the website. The visitor ID may be a unique identifier for a specific visitor assigned by the system, which persists over multiple sessions and multiple sites using the systems script on web pages. In practice, there are many known ways to track users to a website, and any of these may be used. In one example, a first party cookie, a third party, or both thereof are used to identify and track a visitor. A first party cookie has the advantage that almost all visitors using internet browsers will allow the use of first party cookies. A third party cookie has the advantage that the third party is capable of tracking the visitor from one website to the next to identify patterns of use of a visitor to multiple websites. In practice, certain patterns, URL's, and timing may be used to track a visitor if the system for logging data to the data warehouse incorporates information about usage of enough websites.

A page identifier (page ID) may be recorded for each page visited, or the data warehouse may contain only data by page category. Even if the data warehouse has only page category information stored, it might have access to data stored in a separate database, such as a database on remote server, that includes a page ID. The Page ID or page category may be associated with a goal or even the ultimate goal.

In alternative examples, a visitor may enter into a specific product page from a search engine or may enter the website at the home page by typing the domain name of the home page directly in an internet browser. The system checks for a cookie. If one is found, then the system records that the visitor is returning to the website or is new to this website but is a known visitor with a visitor ID already assigned. If a cookie is not found, then the visitor is assigned a new visitor ID (and visitor fields are recorded). An entry page ID is entered into the database of the system, and the referring website is entered, if applicable. This information may be used by the system in analyzing and assigning a visitor quality score or an advertiser quality score, for example.

In one example, the visitor score and the session score are constantly updated during a session. In another example, the session score is constantly updated, but the visitor score is not updated until the end of the session. In yet another example, both the session score and visitor score are updated only at the end of the session. Likewise, a score may be assigned to the referral source, which may be updated during the session or after the session is complete. Click quality scores may be updated long after the session terminates and fields in the data warehouse may be updated if a fraudulent credit card is reported against a purchase or undeliverable contact information is included in a contact form, for example.

The fields of FIGS. 2 and 3 are used in the example of an online retail store. Some fields may not be appropriate for other types of websites, and some additional fields may be necessary to properly capture session parameters for other types of websites. Additionally fields may be added based on demand for additional analytical capabilities by users of the system. Table 1 provides a brief description of fields shown in FIGS. 2 and 3, for example.

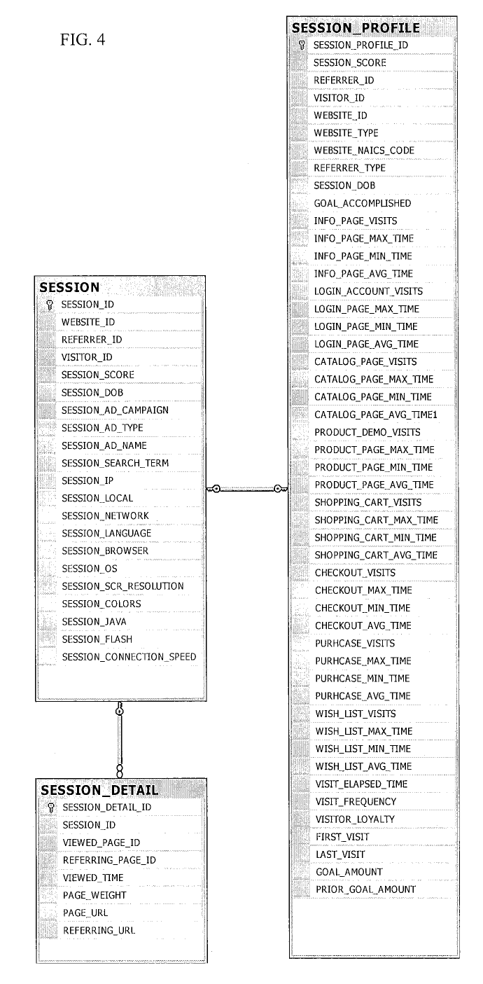

FIG. 4 shows links between Session fields (i.e. session attributes) and Session Profile fields (i.e. session profile attributes) and Session Detail fields, which include attributes such as the Viewed Page ID, Referring Page ID, Viewed Time ID, Page Weight Factor, Page URL and Referring URL. A Session Score may be assigned based on weighting given to access to certain pages and achievement of certain goals. Each session score may be relative to other session scores recorded in the data warehouse, for example. Commercially available and/or third party proprietary data mining algorithms may be applied to the data warehouse to analyze the session profiles for each session stored in the data warehouse. For example, data mining may reduce or increase the weight assigned to sessions that have substantially different attributes, such as page category, industry code and/or assigned goals, than for sessions having similar attributes in these or other areas. Data mining or neural network techniques or both may be applied to determine whether some Session Profile fields, such as the various page max time, page min time and/or page avg time, and/or achieving intermediate goals are correlated more closely with a website achieving its ultimate goal during a session or during multiple sessions by a visitor than other Session Profile fields and/or intermediate goal achievements. Those Session Profile fields and/or intermediate goals that are more closely correlated to achieving a website's ultimate goal may be assigned relatively greater weight in assigning session scores, quality scores for visitors and quality scores for referral websites, such as advertisers, than those page categories and data fields and/or intermediate goals that are less closely correlated to achieving a website's ultimate goal, as is known in the art of data mining and mathematical correlations, for example. The weighting and data mining technique and/or neural network structure used for determining relative scores may be optimized according to known, empirical research about websites having sessions that achieved an ultimate goal and that failed to achieve an ultimate goal, in order to train the system.

A session may time out, ending the session. Return of a user to the web page of the website after a session time out may be considered a new session. A session may be ended by closing of the visitor's browser or exit from the website by entering a new website. The way that a session ends may have an impact on the maximum and minimum times spent on one or more web pages and may be correlated to achievement of the ultimate goal and/or intermediate goals.

In one example, a K-optimal pattern discovery tool is used to list in order a list of associated attributes to the sessions achieving goals, including intermediate goals and an ultimate goal of the website. Also, intermediate goals are checked for an association with achieving the ultimate goal for a session, for a visitor over a series of sessions, and/or for referrals from an advertiser. If intermediate goals are not associated or are associated with failure to achieve the ultimate goal, such as a non-fraudulent purchase, then attributes closely associated with intermediate goals but not closely associated with achieving the ultimate goal may be discounted by reducing the relative weight given to those attributes. If certain attributes are highly correlated with the ultimate goal but are not closely associated with the intermediate goals that are associated with failure or lack of success to achieve the ultimate goal, then these attributes may be more heavily weighted in determining quality scores, such as for visitors, sessions, websites and referring websites. Certain attributes may be associated with intermediate goals that are not associated with successful achievement of the ultimate goal and with achievement of the ultimate goal. These may discounted or may receive some intermediate weighting. A neural network may be taught to provide weighting according to position in a list of K-optimal associations ranked in order of association with achieving the ultimate goal and/or achieving an intermediate goal with or without achieving the ultimate goal, based on session attributes compiled over time for a plurality of visits, a plurality of visitors, and a plurality of websites monitored, for example. A neural network may be trained to weigh attributes. Alternatively, a person may assign weighting factors, which may be used to provide quality scores.

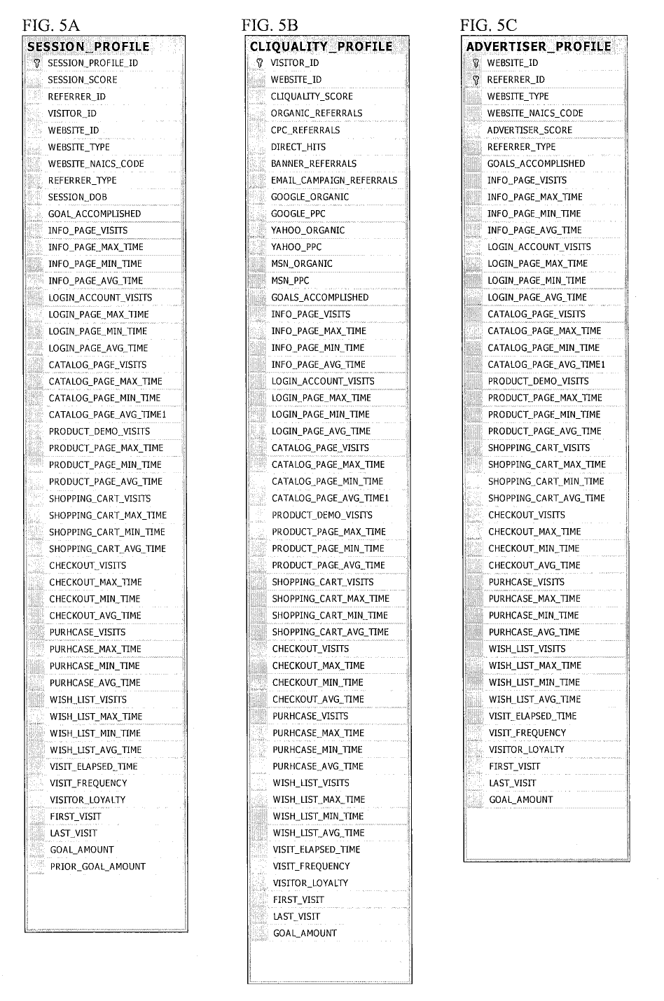

Click quality of a visitor and click quality of an advertiser are examples of click quality scores that may be determined by aggregating data over multiple sessions for multiple users and multiple advertisers. This aggregated data is subsequently data mined and/or subjected to pattern recognition of a neural network to determine a relative click quality score. FIGS. 5A-5C compare fields of (A) a session profile, (B) a visitor click quality profile, and (C) an advertiser click quality profile. These examples are illustrative of the types of attributes that may be used in determining a visitor click quality score and an advertiser click quality score. The attributes listed are not intended to be exclusive, and data mining techniques may be used to suggest additional fields that might be of interest in determining a click quality score.

In one example of an application of the system, the quality score (QS) of a visitor captured by the system may be reported either as an overall score or within a specific category to a website owner or operator. Then, the owner or operator may use the information to offer incentives to the visitor, such as flagging high quality customers for delivery of promotions and/or bonus content to them in real time.

### Advertiser Score

When a visitor starts a session as described in the Session Score section, the system may assign or retrieve a unique Advertiser identifier for the site that referred the visitor to the site monitored by the system. An advertiser's click quality score may incorporate a series of sessions for a plurality of visitors, for example. In one example, an advertiser's click quality score is limited to a specific duration, such as a day, a week, a month or a calendar quarter. A product of the click quality score and the number of sessions and/or the number of visitors (less repeat visits by the same visitor) may be used to compensate an advertiser. In one application, an advertiser may use the system to determine the click quality of visitor's referred to websites by the advertiser and may compensate the websites carrying the advertisements of the advertiser based on the click quality scores of visitors forwarded from websites carrying the advertisements. In another application, an advertiser may choose to delist a website that forwards too many visitors associated with a relatively poor click quality profile and/or too small of a proportionate share of visitors have good click quality profiles (compared to other similar websites, for example).

For example, a visitor came to poochigans.com by clicking on an AdWords ad on Google¹ after searching for “gourmet dog treats”. If the Advertiser Site does not exist in the system, a unique Advertiser Identifier is generated for the referring site. For example, the first time that a visitor is referred to any website of the system by ¹Google is a trademark of Google Inc. and is used here as an example of a search engine and/or website hosting advertisements.

Google, the search engine is provided with a unique identifier by the system. However, if an advertiser already exists in the system, then the advertiser's unique identifier is retrieved along with the Advertiser Profile for the Advertiser.

For example, a visitor used in previous examples came by way of Google, which is a known advertiser. As the visitor completes a Session, such as by a session timeout event, the Session Profile (e.g. FIG. 5A) is associated with the Advertiser Profile (e.g. FIG. 5C) and/or modifies the quality score of the Advertiser and/or the Cliquality Profile of the visitor (e.g. FIG. 5B). As an a example, following the prior example, once the user purchased the product and exited the site, the Session Score modifies Google's Advertiser E-Commerce Score and Google's Overall Advertiser Score, as follows:

Visitor purchased an item giving an E-Commerce session score of 10, on a scale of 1 to 10, which is used to modify the Google Advertiser Score (assume no previous score for simplicity).

If visitor went to another E-Commerce site being referred by Google and purchased again, the Google E-Commerce Score would be 10=((10+10)/2) in this simple example.

If visitor went to another site referred by Google and exited immediately, the Google Score would be reduced, because the Session Score for this last visit would be 1 (on a scale of 1 to 10). Thus, Google E-Commerce score may be recalculated to ((1+10+10)/3), for example, without any specific weighting or updates based on the visitor profile of FIG. 5B.

This example may merely average of all scores, but a visitor might have accessed many other sites monitored by the system, using different referring sites than Google, without any modification to the quality score of Google. As with the score for visitors, the Advertiser scores may be weighted by Categories/attributes. The system may weight the Advertiser Category Score to determine a weighted overall advertiser score. For example, the following example may be used to understand the weighting:
The Google E-Commerce Score is 3 (few users referred purchase)
The Google Informational Site Score is 8 (many users referred are avid user of informational sites)
The Google Social Networking Score is 7 (many users referred are users of Social Networking sites)
The Google Custom Score (for other site types) is a 7
An overall quality score for Google may be determined by taking the category scores, applying a weight to them, and averaging them out. For example, Google's Overall Advertiser Score may be 5 instead of the mathematical average (6.25), if the low E-Commerce score carries more weight than the informational and social networking score, for example.

The system may adjust the weights for categories/fields/attributes based on data warehouse and the data mining algorithms, as disclosed elsewhere, for example. Predictive data mining methods are used to model site-specific behaviors relevant to a desired outcome and/or intermediate goals.

In one example, data mining methods are used to derive predicted session scores. A predictive model based on data mining algorithms may be trained using all the available session profiles. Assuming there are thousands of such sessions, data mining algorithms are capable of identifying the complex interrelationships and weights that relate to usage patterns (as described by the page category attributes and historical attributes, for example) to achieve intermediate and ultimate goals.

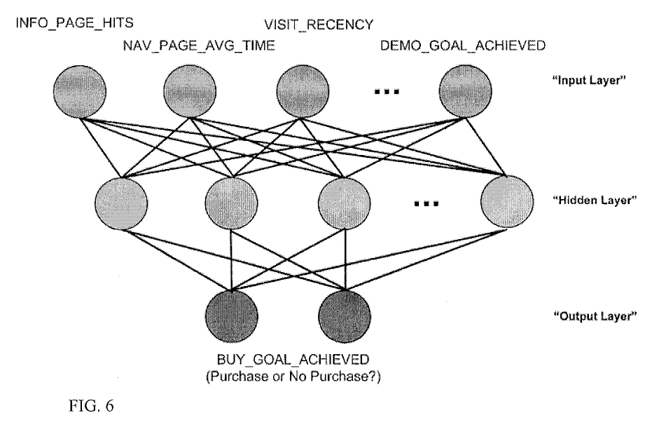

In one example, Session Profiles have goal achievement information, as well as other session attributes, and pattern recognition is accomplished using supervised learning techniques. Many cases with known outcomes may be used to train a neural network, as an example of supervised learning, to predict an ultimate goal, such as a legitimate purchase. An example the layers of a neural net is shown in FIG. 6. A neural network is a powerful, biologically inspired data mining tool that functions as “universal function approximator” (UFA), capturing many complex interactions within a matrix of independent variables. During training (i.e. model building), individual session profile cases are presented to the neural network, together with known outcomes such as purchases. Small iterative adjustments are made to weights in the starting neural network model. This training process allows the neural network to discover the appropriate weights and attribute interactions for use in creating quality scores, which are, functionally, predictive scores of a desired outcome. After training, the neural network is presented with input variables (attributes/fields of the database) that describe a session, visitor and/or advertiser, and the neural network outputs a goal prediction, such as a session quality score, a visitor quality score, or an advertiser quality score. Neural networks may be retrained as often as desired to adapt to a change in patterns or may continually adapt to a changing environment, based on verified, known outcomes. Other data mining methods may be used in combination with neural networks to define predictive attributes and weighting.

Table 2 shows another example of attributes used for data mining and neural network determination of quality scores. Descriptions in Table 2 are illustrative of attributes captured by a system for determining a click quality score.

A neural network model may produce a score characterizing the degree to which a online session compares to known sessions that achieved an ultimate outcome, for example. After a neural network has been trained, it may be used to predict a session score for a specific session. Neural networks (or related data mining algorithms such as support vector machines) are capable of learning preliminary scoring functions by capturing many complex interactions, during a session or over multiple sessions, that relate captured session, visitor, website and advertiser attributes to known outcomes.

In one example, a standard back-propagation neural network is used. The back-propagation learning algorithm includes a training period in which many individual sessions are iteratively presented to the neural network, with small changes made to the weights on a case-by-case basis. During the training phase, each cycle of the back-propagation algorithm feeds the input values (e.g. attributes) forward through the network to produce an output prediction. This outcome prediction, such as an online purchase, is compared against the actual result and an error term is calculated. The error term is then propagated back through the network (from outputs to inputs), which is used to make small corrections to the internal network weights, eventually minimizing the error terms. After many such cycles, the neural network learns the relative importance of each of the attributes to predicting the outcomes. The neural network output is typically a number between 0 and 1, which may be scaled to any quality score range, such as one to scores determine by a neural network may be combined to achieve a neural net score of 0.5. The record of neural net scores from relevant and/or comparatively similar visitors, advertisers, or websites within the data captured by the data warehouse may be used to rank the neural net score of 0.5 against other neural net scores to obtain a relative ranking from 1 to 10 (10 being achievement of the ultimate goal), which may be supplied as the quality score. In one example, the neural net score is compared to historical data for a specified period, such as a week, a month or a year. The neural net score of 0.5, relative to other relevant neural net scores, may yield a quality score in the top deciles (such as a 9) in a relative ranking. Thus, a session quality score of 9 is both data driven and a relative score that is predictive of achieving the desired outcome, such as the ultimate goal of a purchase on a online retail site.

What is claimed is:

1. A system for rating click quality of websites, comprising:
assigning each of a plurality of website pages to one of a plurality of page categories, and assigning at least one of the plurality of page categories as a goal of the website;
monitoring the plurality of website pages of a plurality of websites;
determining the start of an online session by a visitor to one of the plurality of website pages;
assigning the visitor a visitor id;
identifying any referring website from which the visitor originated;
tracking the activity of the online session;
recording session data for each session and each page category visited, including a session id, a number of times that pages of each page category were accessed by the visitor, and at least one parameter related to the duration of access by the visitor to each of the page categories visited by the visitor during the online session.

2. The system of claim 1, wherein the step of recording includes recording a minimum access time for each page category visited during the session.

3. The system of claim 1, wherein the step of recording includes recording a maximum access time for each page category visited during the session.

4. The system of claim 1, wherein the step of recording includes recording a mean or median access time for each page category visited during the session.

5. The system of claim 4, wherein the step of recording includes recording the mean access time.

6. The system of claim 5, wherein the step of recording the mean access time includes summing the total duration of access by the visitor to all pages of the same page category and dividing the sum of the total duration of access by the number of times that pages of the same page category were accessed by the visitor during a session, and storing the result of the step of dividing in the database such that the result of the step of dividing is associated with the session id.

7. The system of claim 6, wherein the step of recording includes recording a standard deviation of the mean access time.

8. The system of claim 1, wherein the step of recording includes recording a minimum access time, a maximum access time, and an indicator of average access time for each page category accessed, the indicator of average access time selected from the group consisting of a mean access time, a median access time, and both a mean access time and a median access time for each page category visited during the session.

9. The system of claim 8, wherein the step of recording includes recording a mean access time.

10. The system of claim 9, wherein the step of recording includes saving the data to a field in a database.

11. The system of claim 10, further comprising:
repeating the steps of monitoring, determining, assigning, identifying, tracking, and recording for a plurality of online sessions of a plurality of websites;
recording the data for each of the plurality of online sessions in a database;
analyzing the data in the database; and
determining a session quality score.

12. The system of claim 11, wherein determining the session quality score includes associating data about a plurality of online sessions in the database to the achievement of the goal of the website, and calculating the session quality score using a data mining tool, a neural network, or both a data mining tool and a neural network.

13. The system of claim 12, wherein determining the session quality score includes limiting data to data for a single one of the plurality of websites.

14. The system of claim 12, wherein determining the session quality score includes using data recorded from a plurality of websites during the step of associating data about a plurality of online sessions.

15. The system of claim 14, wherein the plurality of websites used in the step of using data includes limiting the plurality of websites to websites of a single industry classification code or a single type of website.

16. The system of claim 15, wherein the plurality of websites used in the step of using data are all online retail websites.

17. The system of claim 1, further comprising:
repeating the steps of monitoring, determining, assigning, identifying, tracking, and recording for a plurality of online sessions of a plurality of websites;
recording the data for each of the plurality of online sessions in a database;
analyzing the data in the database; and
determining a session quality score.

18. The system of claim 17, further comprising determining a visitor quality score by comparing each of the plurality of online sessions associated with a single visitor id with a plurality of the plurality of online sessions associated with a plurality of visitor id's, and calculating a comparative rating based on how closely associated the pattern of the plurality of online sessions associated with the single visitor id is with achieving at least one of the goals of at least one of the websites.

19. The system of claim 18, wherein the step of determining the visitor quality score calculates the visitor quality score as a comparative rating based on how closely associated the pattern of the plurality of online sessions associated with the single visitor id is with achieving at least one of the goals over a plurality of the websites.

20. The system of claim 19, wherein the plurality of the websites are limited to a same website type or a same industry code associated with the websites in the database.

21. The system of claim 17, further comprising: calculating a referral website quality score.

22. The system of claim 18, further comprising: calculating a referral website quality score.

23. The system of claim 19, further comprising: calculating a referral website quality score.

24. The system of claim 20, further comprising: calculating a referral website quality score.

25. The system of claim 21, further comprising: establishing an advertising pricing rate based at least in part on the referral website quality score.

26. The system of claim 25, wherein the step of establishing includes adjusting the advertising pricing rate based on a ratio of the referral website quality score and a mean referral website quality store or a ratio of the referral website quality score and a median referral website quality score.

27. The system of claim 26, wherein the step of establishing uses the mean referral website quality store calculated from data limited to the same industry code or the same website type.

28. The system of claim 27, wherein the step of establishing uses the mean referral website quality score calculated from data limited to both the same industry code and the same website type.

29. The system of claim 17, further comprising: ranking a plurality of referral sources by comparing the referral website quality score of each of the plurality of referral sources within a defined category of referral sources.

30. The system of claim 29, wherein the defined category of referral sources is selected from the categories consisting of search engines, news outlets, blogs, auction sites, and social networks.

31. The system of claim 11, further comprising: establishing an advertising rate based at least in part on the session quality score.

32. The system of claim 19, further comprising: blacklisting a visitor based, at least in part, on the visitor quality score of the visitor.

33. The system of claim 21, further comprising: blacklisting an advertiser based, at least in part, on the referral website quality score.

34. The system of claim 19, further comprising: weighting of factors used in determining the visitor quality score, distinguishing low quality visitors, who are unlikely to reach the goal of the website, from high quality visitors, who are most likely to reach the goal of the website.

35. The system of claim 34, wherein the step of weighting includes adjusting the weighting based on dynamic data analysis.

36. The system of claim 1, wherein the step of tracking includes at least one script embedded on each of the plurality of website pages, at least one of the at least one scripts capturing and reporting access by the visitor to one of the plurality of website pages to the system.

37. The system of claim 36, wherein at least one of the at least one scripts captures and reports to the system when a desired intermediate or a desired ultimate goal is achieved by accessing one of the plurality of the plurality of website pages.

38. The system of claim 37, wherein a session including access to the website page associated with an ultimate goal of the website achieves the highest session quality score.

39. The system of claim 38, further comprising:
training a neural network to provide a neural network score from 0 to 1; and
converting the neural network score to an integer quality score from 1 to 10.
